(19) United States
(12) Patent Application Publication
(10) Pub. No.: US 2026/0249986 A1
(43) Pub. Date: Aug. 27, 2026

(54) AIRCRAFT AND AIRCRAFT CONTROL METHOD

(71) Applicant: AERONEXT INC., Tokyo (JP)

(72) Inventor: Yoichi SUZUKI, Tokyo (JP)

(21) Appl. No.: 18/872,671

(22) PCT Filed: Jun. 8, 2022
(86) PCT No.: PCT/JP2022/023156

§ 371 Date: Dec. 6, 2024

(51) Int. Cl. B64C 27/26; B64C 3/56; B64C 25/58; B64C 29/02; B64D 1/08; B64U 10/20; B64U 30/293; B64U 30/295

(52) U.S. Cl. CPC B64C 27/26; B64C 3/546; B64C 3/56; B64C 25/58; B64C 29/02; B64D 1/08; B64U 10/20; B64U 30/293; B64U 30/295

(57) ABSTRACT

Provided is a VTOL aircraft that includes a main wing, a first rotary wing part, and a second rotary wing part, and, during flight using lift generated by the first rotary wing, folds at least a part of the main wing to reduce the plane projection area of the aircraft and makes it less susceptible to updrafts and the like.

### FIELD

The present disclosure relates to an aircraft and an aircraft control method.

### BACKGROUND

In recent years, various services using aircrafts such as drones and unmanned aerial vehicles (UAVs) (hereinafter collectively referred to as “aircrafts”) have been put to practical use. Among these, demand is increasing for applications that require long-distance or long-duration flights, such as home deliveries. An aircraft, commonly called a multicopter, that ascends by the rotation of multiple propellers (hereinafter collectively referred to as a multicopter) does not require a runway for takeoff and landing as a typical fixed-wing aircraft does. This makes it possible to operate in a relatively small space and is suitable for home delivery to detached houses.

However, multicopters tend to have a shorter range than conventional aircrafts, such as airplanes and helicopters. For example, in transportation and research applications, long-duration, long-distance flights are required. In light of this situation, for example, Patent Literature 1 discloses a vertical takeoff and landing (VTOL) type aircraft that can fly long distances by utilizing the lift generated by a main wing in addition to the lift generated by rotary wings.

### CITATION LIST

### Patent Literature

Patent Literature 1: U.S. Pat. No. 10,131,426

### SUMMARY

### Technical Problem

In Patent Literature 1, a VTOL with the main wing in addition to the rotary wings is disclosed, which enables vertical takeoff and landing while reducing the load on the rotary wings and improving the range and payload weight.

However, providing the main wing increases the plane projection area. This increases the effect of airflow received from above or below the aircraft. Unlike a fixed-wing aircraft, VTOL may perform vertical takeoffs and landings. In particular, it is known that when descending an aircraft, the descent becomes difficult due to updrafts and the attitude behavior of the aircraft becomes unstable. In uses where the flight and takeoff/landing environment is not constant, such as transportation and research, it is necessary to improve the takeoff/landing performance in addition to the cruise performance of the aircraft.

In view of this situation, an objective of an aircraft according to the present disclosure is to provide an aircraft capable of improving takeoff/landing performance in the VTOL system.

### Solution to Problem

According to the present disclosure, an aircraft can be provided, the aircraft including: a body part; a main wing extending in a horizontal direction from the body part so as to intersect with a longitudinal direction; and a rotary wing part disposed on the aircraft, the main wing having, at a position in the main wing outside the body part, a rotary portion that is able to rotate an outer portion of the main wing outside the position in the main wing, along a rotation direction with a rotation axis being the longitudinal direction, with respect to an extension direction of the main wing.

According to the present disclosure, an aircraft control method can be provided, the aircraft including: a body part; a main wing extending in a horizontal direction from the body part so as to intersect with a longitudinal direction; and a rotary wing part disposed on the aircraft, the main wing having, at a position in the main wing outside the body part, a rotary portion that is able to rotate an outer portion of the main wing outside the position in the main wing, along a rotation direction with a rotation axis being the longitudinal direction, with respect to an extension direction of the main wing, the aircraft control method including controlling the main wing to bring the main wing to a folded state by the rotary portion when the aircraft moves downward for landing during flight of the aircraft.

Other problems disclosed in the present application and their solutions will be clarified in the description of embodiments and in the drawings.

Advantageous Effects of Invention According to the present disclosure, an aircraft that can improve takeoff/landing performance in the VTOL system can be provided.

### BRIEF DESCRIPTION OF DRAWINGS

FIG. 1 is a schematic view of an aircraft according to the present disclosure, viewed from above.

FIG. 2 is a schematic view of the aircraft of FIG. 1 viewed from the side.

FIG. 3 is a schematic view of the aircraft of FIG. 1 viewed from the front.

FIG. 4 is a top view of the aircraft of FIG. 1 when it takes off and lands.

FIG. 5 is a side view of the aircraft of FIG. 4.

FIG. 6 is a front view of the aircraft of FIG. 1 when it lands.

FIG. 7 is a functional block diagram of the aircraft of FIG. 1.

FIG. 8 is a side view of the aircraft when a main wing is folded upward.

FIG. 9 is another front view of the aircraft when the main wing is folded upward.

FIG. 10 is a front view of the aircraft when the main wing is folded upward.

FIG. 11 is a side view of the aircraft when the main wing is folded downward.

FIG. 12 is another front view of the aircraft when the main wing is folded downward.

FIG. 13 is another front view of the aircraft when the main wing is folded downward.

FIG. 14 is a view of the aircraft of FIG. 13 when it lands.

FIG. 15 is a front view of the aircraft with wingtip portions functioning as winglets.

FIG. 16 is a front view of the aircraft with wingtip portions in the shape of a chip tank.

FIG. 17 is a side view of the aircraft of FIG. 16.

FIG. 18 is a side view illustrating an example of a method of loading a payload onto the aircraft.

FIG. 19 is a top view of an example of the installation of a battery and the payload on the aircraft.

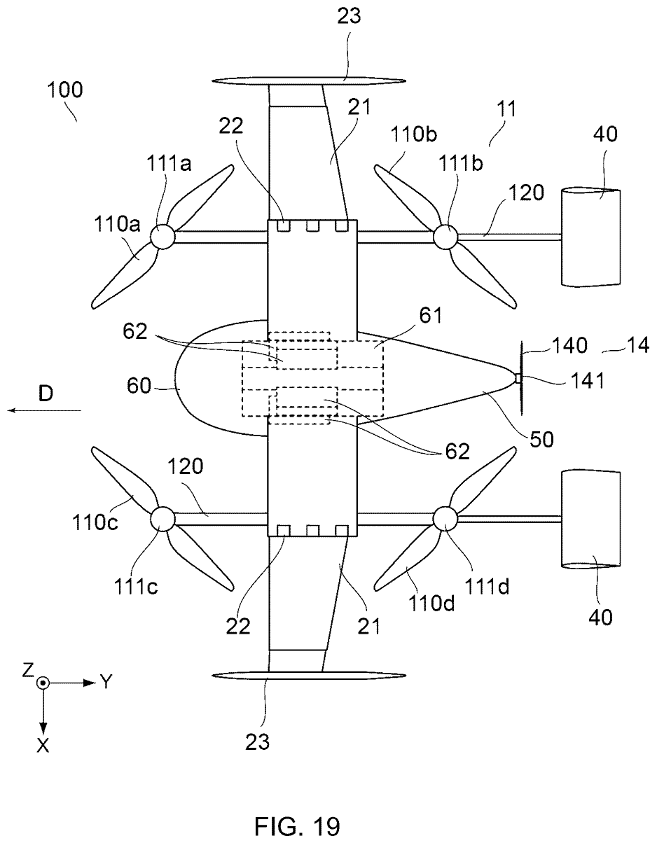

FIG. 20 is a side view of the aircraft of FIG. 20.

FIG. 21 is a front view of the aircraft of FIG. 20.

FIG. 22 is a front view of the aircraft of FIG. 20 when it detached the payload and took off again.

### DESCRIPTION OF EMBODIMENTS

The following lists and describes the contents of embodiments of the present disclosure. An aircraft according to the embodiments of the present disclosure has the following configuration.

### Item 1

An aircraft including:
a body part;
a main wing extending in a horizontal direction from the body part so as to intersect with a longitudinal direction; and
a rotary wing part disposed on the aircraft, the main wing having, at a position in the main wing outside the body part, a rotary portion that is able to rotate an outer portion of the main wing outside the position in the main wing, along a rotation direction with a rotation axis being the longitudinal direction, with respect to an extension direction of the main wing.

### Item 2

The aircraft according to item 1, in which the main wing includes, at a tip portion of the main wing, a landing portion that is able to be installed on a landing surface in a downward rotated state.

### Item 3

The aircraft according to item 1 or 2, in which the rotary portion is disposed such that the outer portion of the main wing is rotatable by 90 degrees or more with respect to the extension direction of the main wing.

### Item 4

The aircraft according to any one of items 1 to 3, in which the main wing includes a shock mitigation device.

### Item 5

The aircraft according to item 4, in which the shock mitigation device is disposed on the main wing and is deformable or movable in the extension direction of the main wing.

### Item 6

The aircraft according to any one of items 1 to 5, in which the rotary wing part includes a rotary wing part that generates vertical thrust against the aircraft.

### Item 7

The aircraft according to any one of items 1 to 6, in which the rotary wing part includes a rotary wing part that generates horizontal thrust against the aircraft.

### Item 8

The aircraft according to any one of items 1 to 4, in which the body part is configured to be able to mount a payload and a plurality of batteries inside.

### Item 9

The aircraft according to item 8, in which the body part is configured to be able to feed the payload downward when the payload is detached.

### Item 10

The aircraft according to item 8 or 9, in which the batteries are positioned with a space in between, in which the payload is mounted.

The aircraft according to item 10, in which when the body part is viewed from front, the space in which the mounting part is mounted extends from above to below.

### Item 12

An aircraft control method for controlling an aircraft,
the aircraft including:
   a body part;
   a main wing extending in a horizontal direction from the body part so as to intersect with a longitudinal direction; and
   a rotary wing part disposed on the aircraft,
the main wing having, at a position in the main wing outside the body part, a rotary portion that is able to rotate an outer portion of the main wing outside the position in the main wing, along a rotation direction with a rotation axis being the longitudinal direction, with respect to an extension direction of the main wing,
the aircraft control method including controlling the main wing to bring the main wing to a folded state by the rotary portion when the aircraft moves downward for landing during flight of the aircraft.

### Item 13

The aircraft control method according to item 12, including controlling the main wing to bring a part of the main wing into contact with a landing surface when the aircraft lands.

### Details of Embodiments According to Present Disclosure

The following describes the aircraft according to embodiments of the present disclosure with reference to the drawings.

### Details of First Embodiment

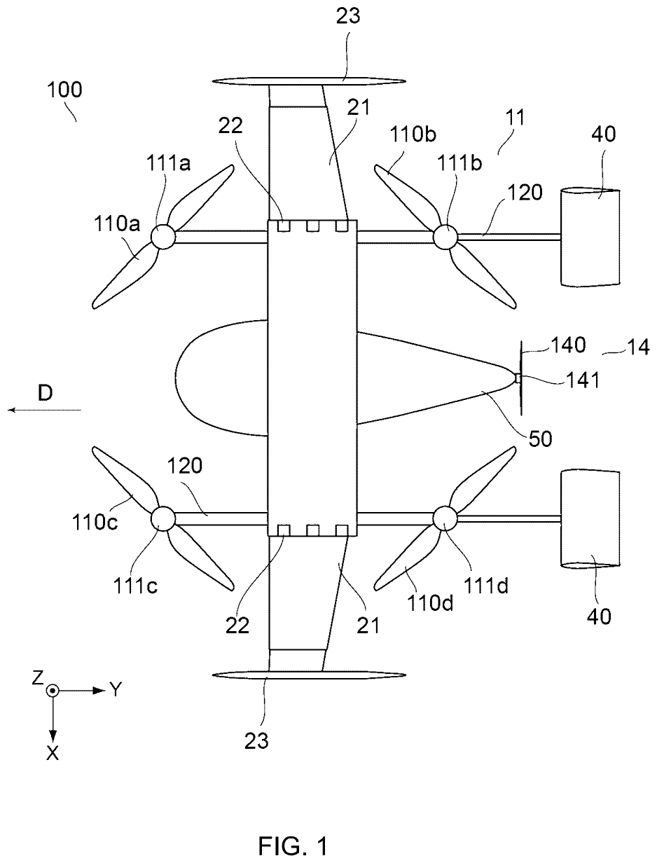

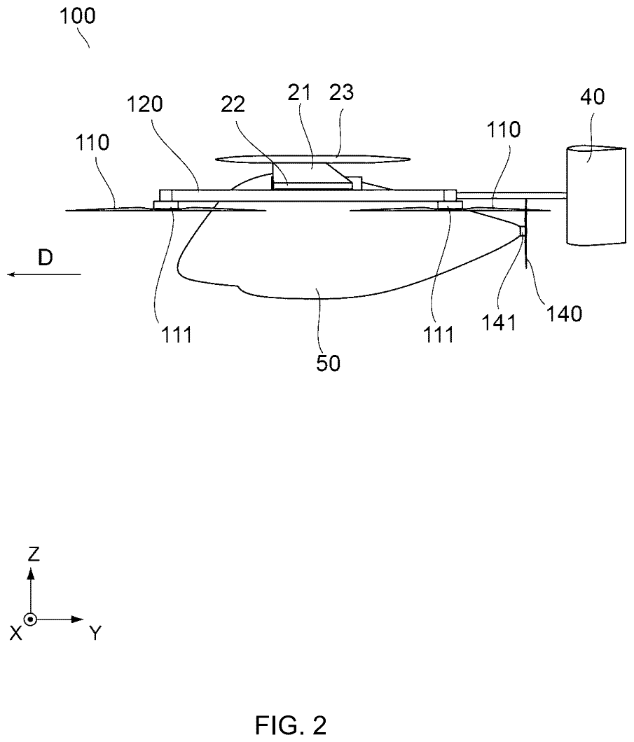

As illustrated in FIGS. 1 and 2, an aircraft 100 according to the present embodiment is a vertical takeoff and landing (VTOL) aircraft capable of vertical takeoff and landing.

The aircraft 100 takes off from a takeoff point and flies to its destination. For example, in the case of an aircraft 100 making a delivery, the aircraft 100 reaches its destination, and completes the delivery by landing at a port or other location or hovering above the port or other location, and detaching a package it has carried. After detaching the package, the aircraft 100 travels by flight to other destinations, such as the original takeoff point or other delivery points, for example.

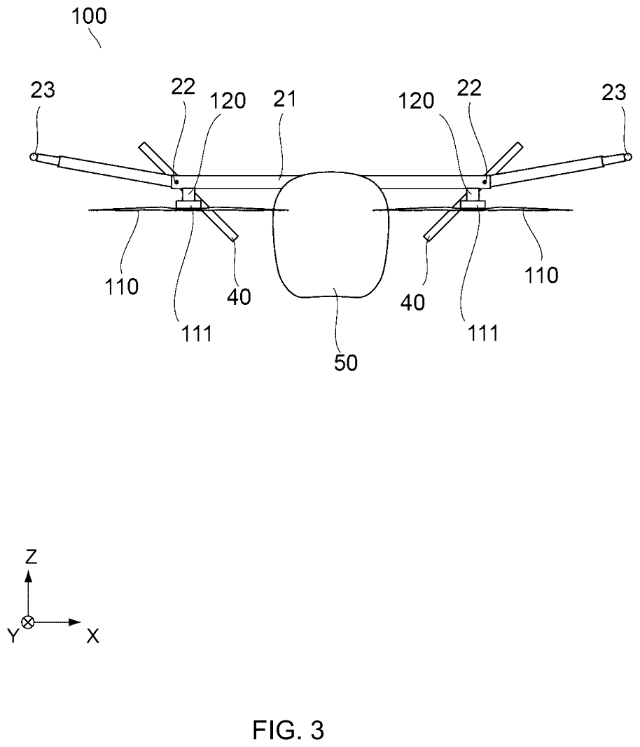

As illustrated in FIGS. 1 through 3, the aircraft 100 according to the present embodiment includes a body part 50, a main wing 21, a first rotary wing part 11, and a second rotary wing part 12. The main functions of the body part 50 are described below. The main wing 21 is disposed in a manner extending in the horizontal direction (e.g., an X-axis direction described below) from the body part 50 so as to intersect with the longitudinal direction (a Y-axis direction described below). The main wing 21 includes a pair of frames 120 extending in the longitudinal direction. The rear end of each frame 120 is provided with a tail 40. The shape of the tail 40 is not limited, but the tail 40 in the present embodiment is what is called a wing shape. The tail 40 according to the present embodiment is inclined from the outside to the inside in the width direction from above to below, as viewed from the front. This allows the tail 40 to function as both a horizontal tail and a vertical tail. The increase in weight and aerodynamic drag can be reduced compared to the case where a frame connecting between the pair of frames 120 is provided to connect a T-tail, or a horizontal tail connecting between the pair of frames 120 is provided to make a twin tail. Even when the tail 40 includes a moving blade, the number of moving parts can be reduced because it is a ruddervator that serves as both a rudder and an elevator.

The first rotary wing part 11 (111a, 111b, 111c, 111d) according to the present embodiment includes a propeller 110 and a motor 111. The first rotary wing part 11 may be disposed on the frame 120. For example, the first rotary wing part 11 is disposed at the front, middle, or rear end of the frame 120. It is desirable that the aircraft 100 include an energy source (e.g., secondary battery, fuel cell, fossil fuel, etc.) for powering the first rotary wing part 11. For example, as described below, the aircraft 100 may include a battery in the body part 50.

The second rotary wing part 14 includes a propeller 140 and a motor 141. The second rotary wing part 14 may be disposed, for example, on the body part 50. The aircraft 100 has an energy source (e.g., secondary battery, fuel cell, fossil fuel, etc.) for powering the second rotary wing part, which may be shared as the energy source of the first rotary wing part 11, or separate energy sources may be provided for the first and the second rotary wing parts.

The aircraft 100 illustrated in the drawings is depicted in simplified form to facilitate the explanation of the structure of the present disclosure, and the detailed configuration of a control unit, for example, is not illustrated.

The forward direction of the aircraft 100 is the direction of arrow D (−Y direction) in the drawings (see below for details).

In the following descriptions, different terms may be used according to the following definitions. Longitudinal direction: +Y and −Y directions, upper-lower direction (or vertical direction): +Z and −Z directions, left-right direction (or horizontal direction): +X and −X directions, forward direction (front): −Y direction, backward direction (rear): +Y direction, ascending direction (upward): +Z direction, descending direction (downward): −Z direction

The propeller 110 (140) rotates upon receiving an output from the motor 111 (141). The rotation of the propeller 110 (140) generates propulsive force to fly the aircraft 100. The propeller 110 (140) can rotate clockwise, stop, and rotate counterclockwise.

The propeller 110 (140) included in the aircraft of the present disclosure has one or more blades. Any number of blades (rotors) (e.g., 1, 2, 3, 4, or more blades) may be included. The shape of the blades can be any shape, such as flat, curved, kinked, tapered, or a combination thereof. The shape of the blades is adjustable (e.g., telescoping, folding, bending, etc.). Each of the blades may be symmetrical (having identical upper and lower surfaces) or asymmetrical (having differently shaped upper and lower surfaces). The blades can be formed into airfoils, wings, or any geometry suitable for generating aerodynamic forces (e.g., lift, thrust) as the blades are moved through the air. The geometry of the blades can be selected as appropriate to optimize the aerodynamic characteristics of the blades, such as increasing lift and thrust and reducing drag.

The propellers included in the aircraft of the present disclosure may be, but are not limited to, fixed pitch, variable pitch, or a mixture of fixed and variable pitch propellers.

The motor 111 (141) produces rotation of the propeller 110 (140). For example, a drive unit can include an electric motor or engine. The blades can be driven by the corresponding motor and rotated around the rotation axis of the motor (e.g., the long axis of the motor).

The blades can all rotate in the same direction or independently. For example, some of the blades may rotate in one direction while others rotate in the other direction. The blades can all rotate at the same rotational speed, or they can each rotate at a different rotational speed. The rotational speed can be determined automatically or manually based on the dimensions of the mobile bodies (e.g., size, weight) and control conditions (speed, direction of movement, etc.).

The aircraft 100 determines the rotational speed of each motor and the angle of flight through a flight controller according to wind speed and direction, using inputs from a proportional control system or by a program, which is not illustrated in the drawings. This allows the aircraft to perform movements such as ascending and descending, accelerating and decelerating, and changing directions.

The aircraft 100 can also fly autonomously according to a route and a rule set in advance or during the flight, or by using a proportional control system to control the flight.

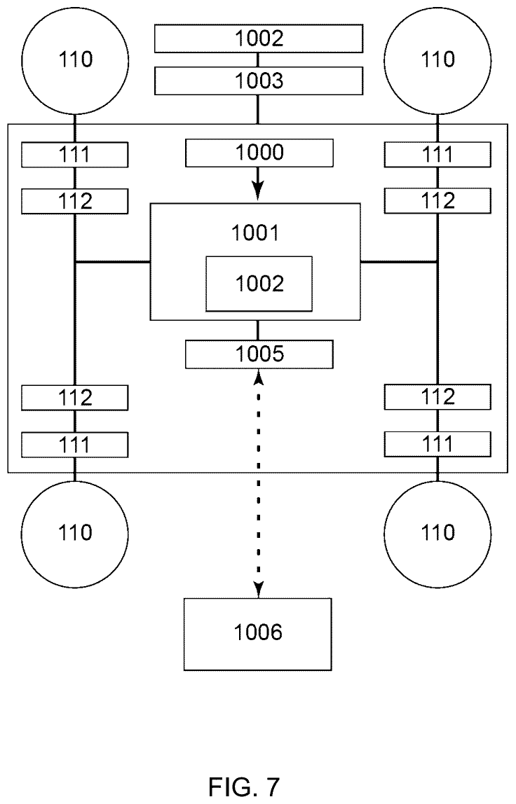

The aircraft 100 described above has some or all of the functional blocks illustrated in FIG. 7. The functional blocks in FIG. 7 are examples of minimum reference configurations. A light controller 1001 is what is called a processing unit. The processing unit can have one or more processors such as a programmable processor (e.g., central processing unit (CPU)). The processing unit has a memory, not illustrated, that can be accessed. The memory stores logic, code, and/or program instructions that can be executed by the processing unit to perform one or more steps. The memory may include, for example, separable media such as a secure digital (SD) card, a random access memory (RAM), or an external storage device. Data acquired from a sensor or the like 1002 may be directly transmitted to and stored in the memory. For example, still and moving image data captured by a camera or other device is recorded in an internal or external memory.

The processing unit includes a control module configured to control the state of a rotorcraft. For example, the control module controls a propulsion mechanism (e.g., motor) of a rotorcraft with six degrees of freedom (translational motions x, y, and z, and rotational motions θx, θy, and θz) to adjust the spatial arrangement, velocity, and/or acceleration of the rotorcraft. The control module can control one or more of the states of a mounting part and a sensor or the like.

The processing unit can communicate with a transmission/reception unit 1005 configured to transmit and/or receive data from one or more external devices (e.g., terminals, display units, or other remote controllers). The transmission/reception unit 1006 can use any suitable means of communication, such as wired or wireless communication. For example, the transmission/reception unit 1005 can use one or more of local area network (LAN), wide area network (WAN), infrared, wireless, WiFi, point-to-point (P2P) network, telecommunications network, cloud communications, and other means. The transmission/reception unit 1005 can transmit and/or receive one or more of data acquired by the sensor or the like 1002, processing results generated by the processing unit, predetermined control data, and user commands from a terminal or remote controller.

The sensor or the like 1002 according to the present embodiment may include an inertial sensor (accelerometer, gyroscope), a GPS sensor, a proximity sensor (e.g., lidar), or a vision/image sensor (e.g., camera).

The aircraft 100 according to the embodiment of the present disclosure can ascend by actuation of the first rotary wing part 11 and move in the horizontal direction by actuation of the second rotary wing part 12. When moving forward, the aircraft can fly in the forward direction using the lift generated by the main wing 21.

The first rotary wing part 11 according to the present embodiment includes at least two or more rotary wings. The propeller rotation axis of each rotary wing is along a direction that includes the upper-lower direction (Z direction) component. This can generate vertical thrust for the aircraft 100. The second rotary wing part 14 according to the present embodiment includes at least one rotary wing. The propeller rotation axis of the rotary wing is along a direction that includes the longitudinal direction (Y direction) component. This can generate horizontal thrust (e.g., longitudinal direction) for the aircraft 100.

For vertical takeoff and landing of the aircraft 100, it is preferable that the lift generated by the first rotary wing part 11 can lift the aircraft 100 without using the lift generated by another rotary wing or by the main wing 21.

It is desirable that the main wing 21 have a substantially airfoil shape that generates lift upward (+Z direction) when air strikes it from its front edge. By using the upward lift generated by the main wing 21 when the aircraft 100 moves forward, the thrust by the second rotary wing part 12 can be either not used or used less while the aircraft 100 is moving, which can improve efficiency in flight.

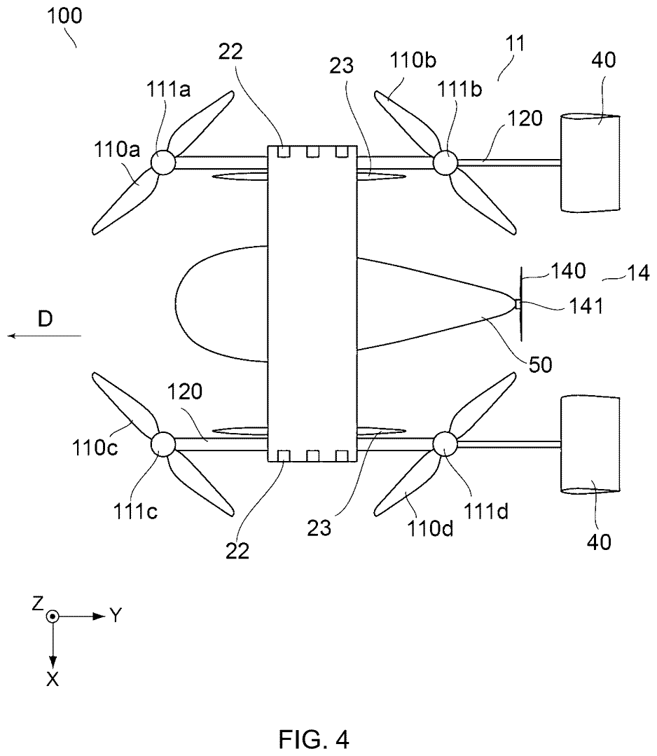

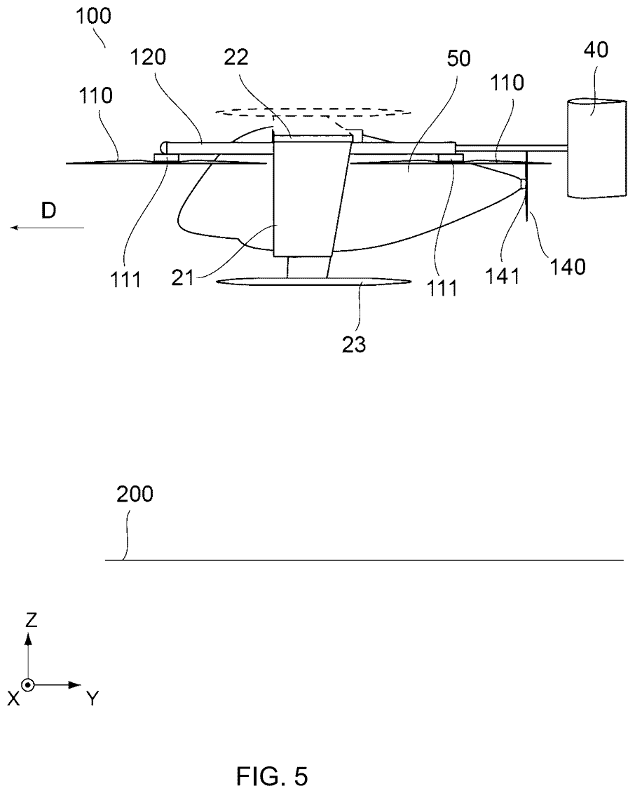

As illustrated in FIGS. 4 to 6, the main wing 21 according to the present embodiment can be folded at predetermined positions (rotary portions 22). Each of the rotary portions 22 is disposed, for example, at a position outside the position where the body part 50 is disposed, in the width direction of the main wing 21. The rotary portion 22 has the rotation axis extending in the longitudinal direction of the aircraft 100, and has the function of rotating downward an outer portion in the width direction outside the rotary portion 22 of the main wing 21

When the main wing 21 is folded, the plane projection area of the aircraft 100 (the area occupied by the plane component of the aircraft 100 when viewed from above) decreases, as illustrated in FIGS. 4 to 6. In case of a typical VTOL aircraft, the aerodynamic drag of the aircraft increases due to the presence of the main wing during vertical descent, generating unintended lift on the aircraft, making it difficult to control the descent of the aircraft 100. In other flight states of the aircraft (e.g., hovering), the aircraft 100 will also be strongly affected by updrafts and downdrafts due to the large plane projection area caused by the presence of the main wing.

When the aircraft is to descend to a desired altitude or to stay at the desired altitude, the rotational speed of the propeller of each rotary wing part on the aircraft is controlled to be lowered. At this time, even if the rotational speed of the propeller is reduced, the altitude of the aircraft is not lowered due to the air resistance received by the main wing, which may make it difficult to maintain the aircraft's attitude in the air because the rotational speed of the propeller is not sufficient to maintain the aircraft's attitude.

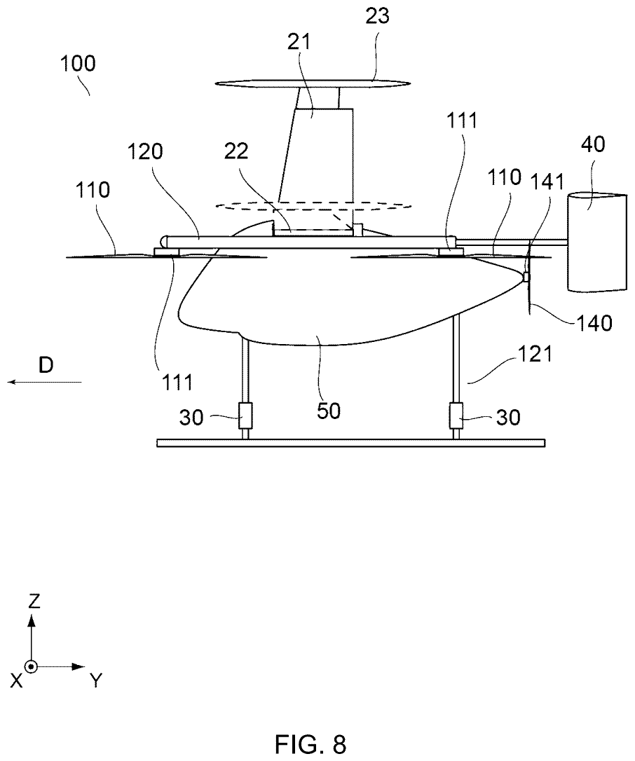

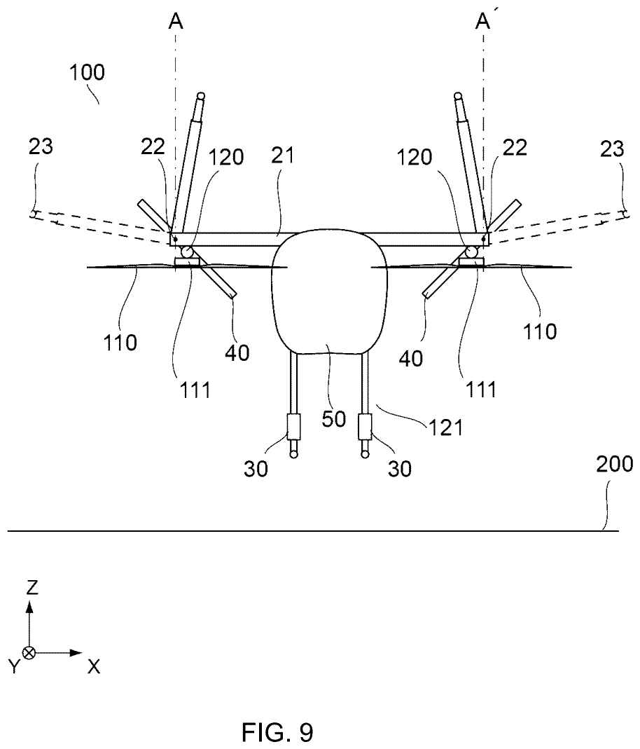

The rotary portion 22 that folds the main wing 21 is configured to allow the main wing 21 to fold at a predetermined angle upward or downward, as illustrated in FIGS. 8 and 9. As described above, the rotation axis of the rotary portion 22 is along the longitudinal direction of the aircraft 100. For example, a known mechanism such as a pin, hinge, or arm may be used as the rotation axis. These mechanisms can also be combined with a damper, a motor, and other devices to allow for slow folding. The number of axes and the direction of extension need not be limited to one, and the main wing may have a plurality of rotary portions or be folded diagonally backward or forward.

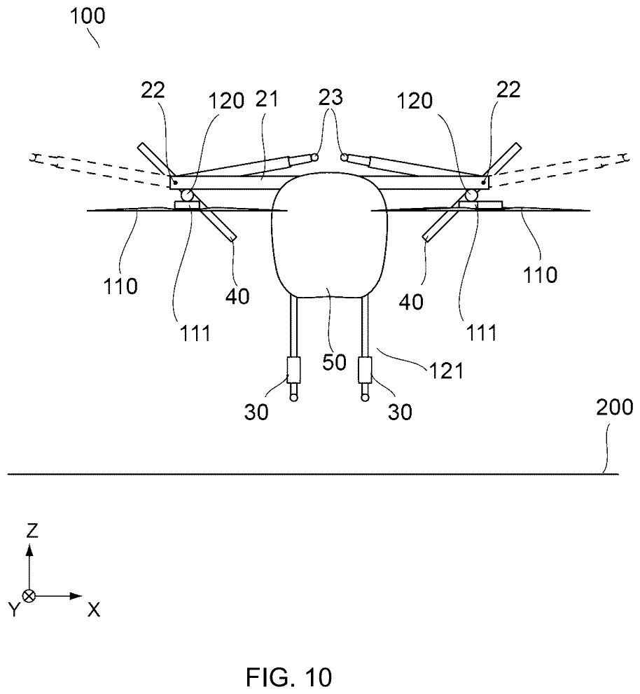

When the folded main wing 21 is positioned on the center side of the aircraft with respect to axes A and A′, which are axes in the Z direction passing through the centers of the folds, the plane projection area of the wing 21 is the smallest, making it suitable for descent or the like. When the main wing 21 is folded more and the angle of the main wing 21 approaches the horizontal as illustrated in FIG. 10, not only the plane projection area but also the side projected area (the area occupied by the plane component of the aircraft 100 when viewed from the width direction) decreases. A reduction in the side projected area can reduce the effect of wind on the aircraft 100 from the sides. This can further improve the stability of the aircraft 100. The time of folding the main wing 21 may be, for example, when the aircraft is hovering above a destination before beginning its descent, or during the descent.

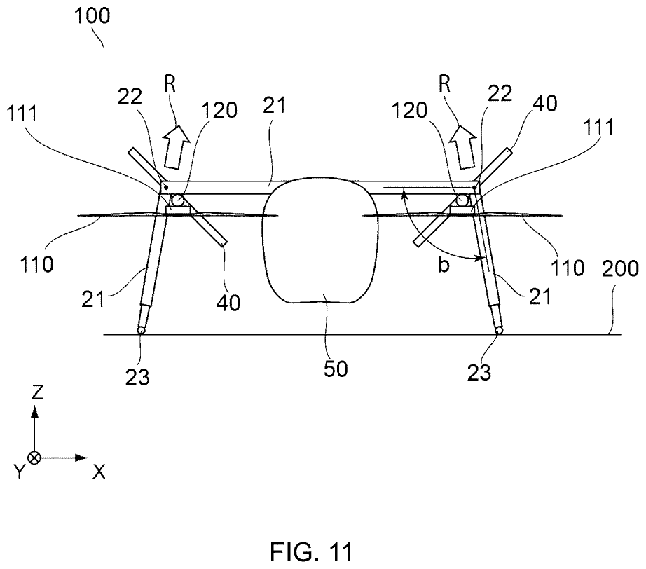

As a modification, as illustrated in FIG. 11, outer portions of the main wing 21 can be rotated downward to use the portions as landing legs. By setting the direction in which the main wing 21 is folded to be below the aircraft (−Z direction), and by making the tips of the main wing 21 protrude below the lowest part of the aircraft 100 (e.g., the bottom of the body part 50) when the main wing 21 is folded, the body part 50 or a payload (such as an item mounted in a manner protruding further downward from the body part 50) does not touch a landing surface 200, and only the main wing 21 can be used to park the aircraft. This can eliminate the need for separate landing legs on the aircraft 100, thereby reducing an increase in weight of the aircraft 100. The portions of the main wing 21 that contact the landing surface 200 (e.g., tip portions of the main wing 21 but not limited thereto) may include respective landing portions 23. The landing portions 23 are made of a different material from that of the main wing 21 and can, for example, function as a non-slip or shock absorber.

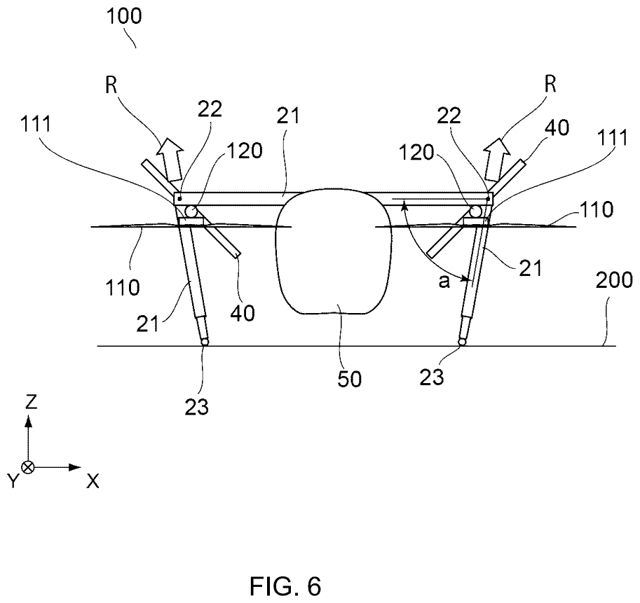

When parts of the main wing 21 also serve as landing legs, the wing 21 will be subjected to impact during takeoff and landing. When the angle of the folded main wing to the landing surface is either right angle b, with the main wing 21 folded perpendicularly at the rotary portions 22, as illustrated in FIG. 11, or obtuse angle c, with the main wing 21 folded outward in the width direction at the rotary portions 22, the distance between the landing legs is wider. However, since impact force R of takeoff and landing is transmitted to the rotary portions 22 and the inside of the main wing, the body part 50 of the aircraft 100 may be affected depending on the magnitude of the impact. In the present embodiment, the outer portions of the main wing 21 can be rotated more than 90 degrees with respect to an extension direction (width direction) of the main wing 21. In other words, as illustrated in FIG. 6, when the angle of the folded main wing 21 is acute (i.e., the folded main wing 21 is folded inward in the width direction from the rotary portions 22), the impact force R is directed outward from the rotation axis portions, so that even if a strong impact that the rotary portions 22 cannot withstand is applied, the impact on the body part 50 can be suppressed. It is desirable that the folding angle of the main wing 21 is selected to suit the surrounding environment of the location where the aircraft is to take off, land, or park, the takeoff weight and landing speed of the aircraft 100, and other factors. The main wing 21 may or may not be folded at takeoff. When parts of the main wing 21 function as landing legs, as illustrated in the drawings, the main wing 21 is folded at takeoff and may be rotated to return to its original position during ascend, before beginning horizontal flight after completing the ascend, or after beginning horizontal flight.

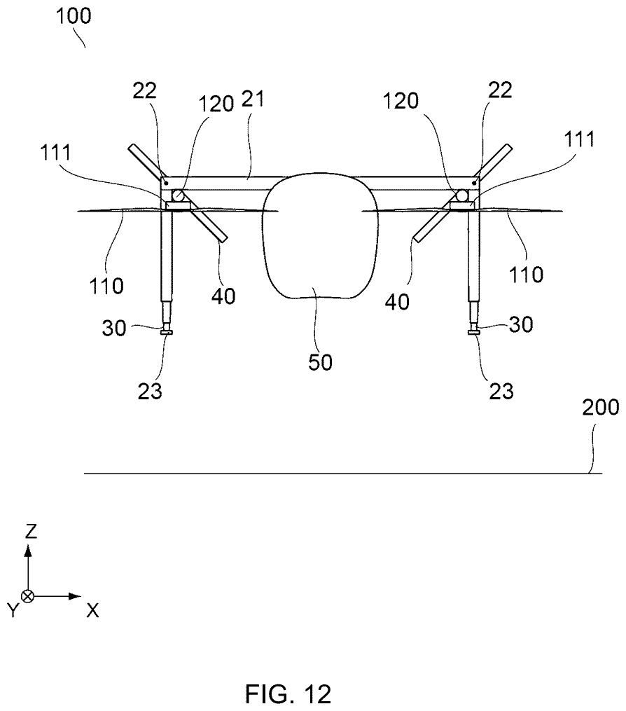

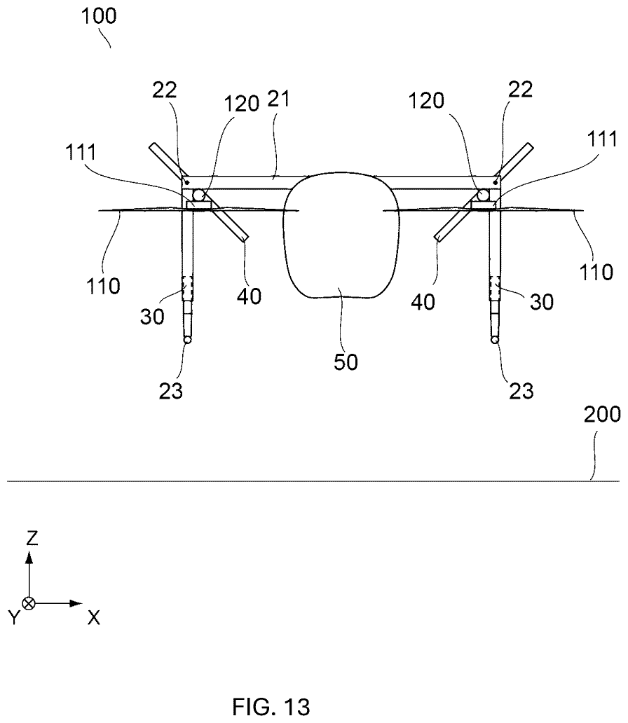

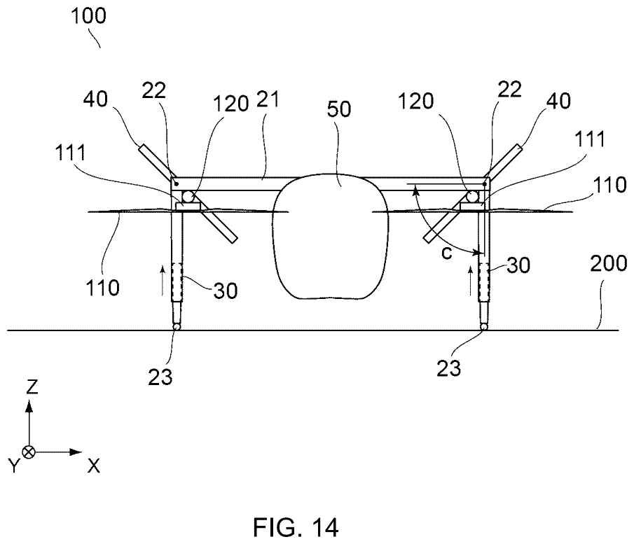

The aircraft 100 may also include a shock mitigation device 30 such as a damper and an absorber for shock mitigation during takeoff and landing. For example, the shock mitigation device 30 may be disposed at each wingtip as illustrated in FIG. 12, or between the wingtip and the rotary portion 22 of the main wing 21 as illustrated in FIGS. 13 and 14. The configuration, mechanism, and position of the shock mitigation device is not limited to the examples illustrated in the drawings, as long as the shock transmitted from a landing part is attenuated before it reaches the body part 50.

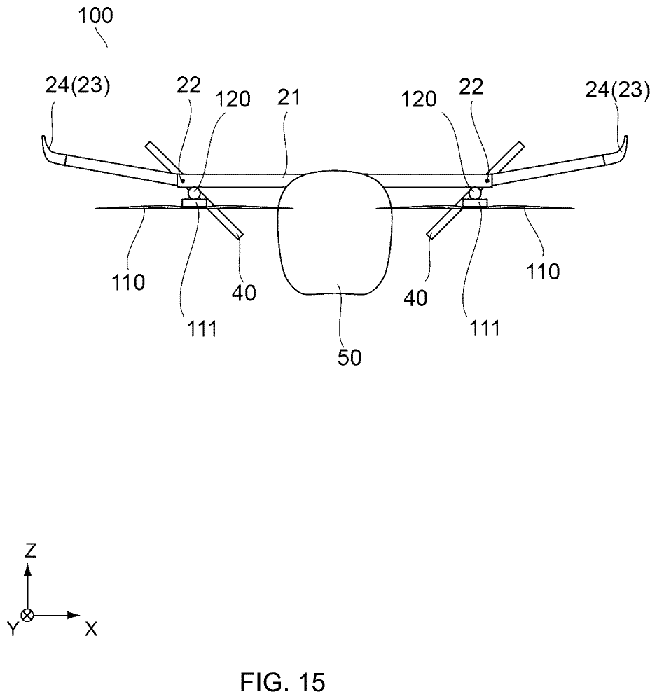

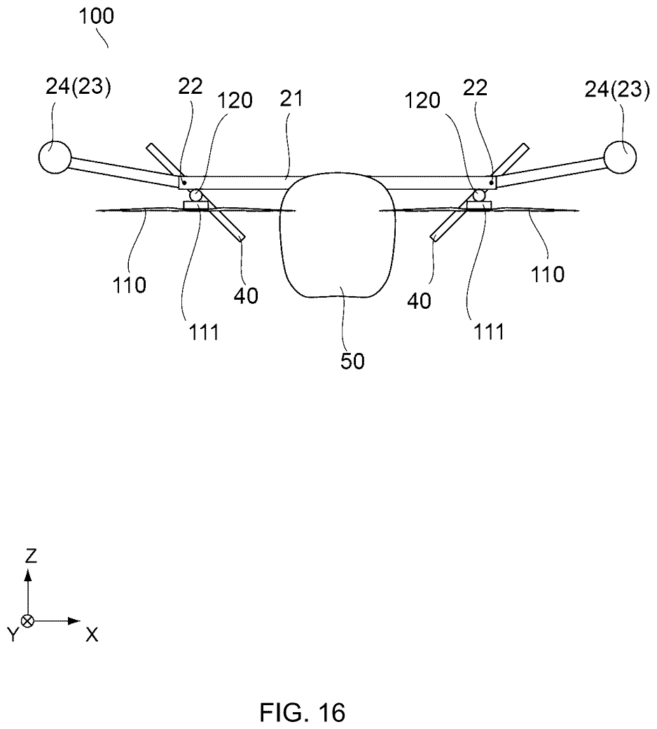

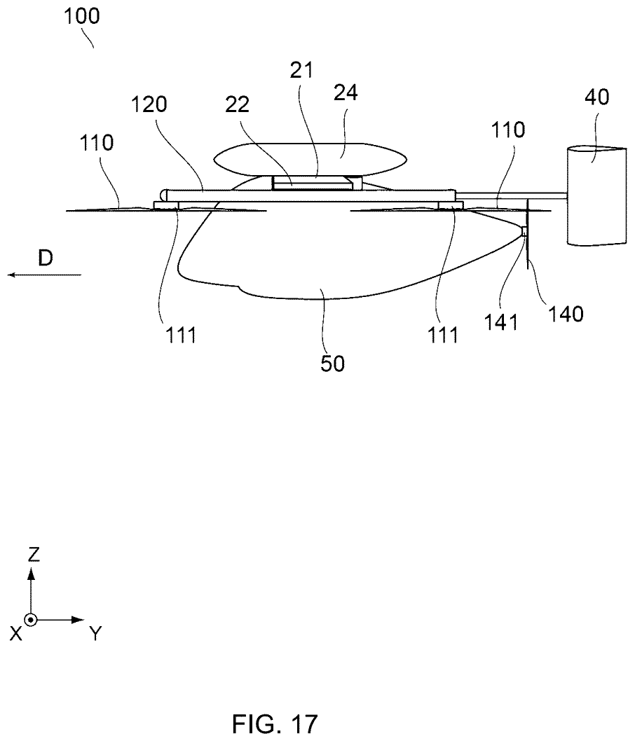

Wingtip portions 24 of the main wing 21 may include the respective landing portions 23 that contact the landing surface during landing. The shape of the wingtip portions 24, such as a winglet or a wingtip tank as illustrated in FIGS. 15 to 17, can also have the effect of reducing the aerodynamic drag caused by a wingtip vortex, preventing the concentration of weight on a root of the main wing, or the like, and can further serve as a landing portion.

The body part 50 may be able to contain some or all of the processing unit, the battery, the mounting part, and the like. The body part 50 may have a shape that is optimized based on the attitude of the aircraft 100 during cruise that is expected to be maintained for an extended period of time during the movement of the aircraft 100 (“cruising attitude”). This improves flight efficiency, which can shorten flight time and increase range.

It is desirable that the body part 50 have an outer skin that is strong enough to withstand flight and takeoff and landing. For example, plastics and FRP are suitable materials for the outer skin because of their rigidity and waterproof properties.

The structure of the aircraft 100, including the frames 120 and the body part 50, is formed by a monocoque, ladder frame, or other structure. A motor mount, the frames 120, and the body part 50, which are included, may be constructed by connecting the parts together, or they may be molded as a single unit using a monocoque structure or integral molding. For example, the motor mount and the frames 120 may be molded as one piece, or the motor mount, the frames 120, and the body part 50 may all be molded as one piece. By integrating the parts into a single piece, it is possible to smooth the joints between the parts. This can be expected to reduce drag and improve fuel efficiency, as in the case of a blended wing body and a lifting body.

The shape of the aircraft 100 may be directional. Directionality refers to the property of a shape that is suitable for flying in a particular direction, unlike what is called general multicopters and the like. For example, a shape that improves flight efficiency when the nose of the aircraft is facing directly into the wind, such as a streamlined body part that reduces drag in the cruising attitude of the aircraft 100 in no wind.

The mounting part is a part that can be contained in or connected to the body part 50. The mounting part can be configured, for example, to hold a payload, or more preferably to contain the payload. Although the payload in the present embodiment is described as an example of a package or a shipping box that serves as the packing material for the package, the present technology is not limited to such examples. Payloads may include, for example, commodities, books, food, and other packages delivered by dealers, as well as equipment such as cameras, sensors to inspect structures, and actuators, and other objects that can be carried by a flight section. There may be a single or multiple objects constituting the mounting part.

The mounting part may be fixed to the body part or may be connected to the body part independently and displaceably. When connected independently displaceably to the body part, the mount part can keep a payload in a predetermined attitude (e.g., horizontal) regardless of the attitude of the aircraft 100, by being connected independently and displaceably via a connection such as a rotation axis or a gimbal with one or more degrees of freedom. The displacement method can be selected between a passive method, which is performed by its own weight, and an active method, which is controlled by using a motor, a servo, or the like.

If the mounting part is not displaced independently, space for displacement and swing of the mounting part is not needed. This minimizes the size of the body part, which can improve flight efficiency. When the mounting part is independently displaceable, the center of gravity of the body part is constant regardless of the center of gravity of the mounting part. This can improve the stability of the aircraft. It is desirable that these configurations are selected as suitable, taking into account various trade-offs.

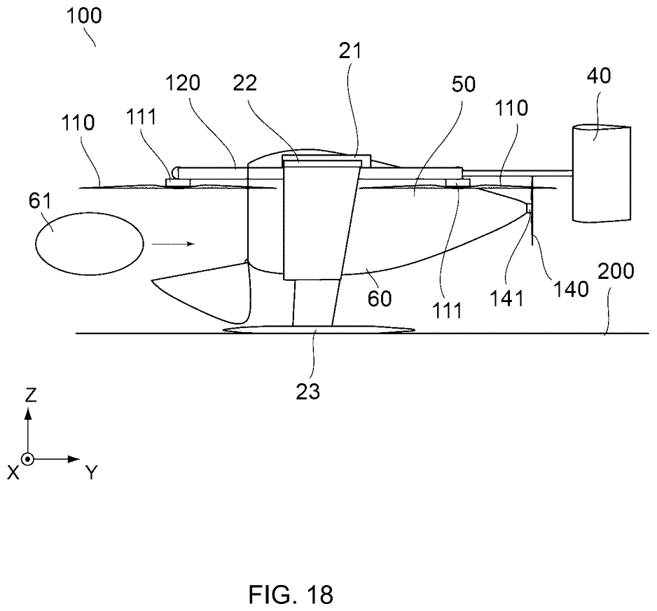

When a battery, a heavy payload, or the like is placed by hand, it may be difficult to push it up from below the aircraft. Therefore, as illustrated in FIG. 18, for example, the interior of the body part 50 is configured to be accessible from the front of the aircraft so that the installation of a battery and the placement of a payload on the aircraft 100 (body part 50) can be simplified. The direction of access to the interior of the body part 50 is not limited to from the front of the aircraft 100, but a similar effect can be obtained by an access from the rear or side of the aircraft 100.

### Details of Second Embodiment

In the details of a second embodiment according to the present disclosure, the same components as those in the first embodiment operate in a similar manner, and thus the description thereof will be omitted.

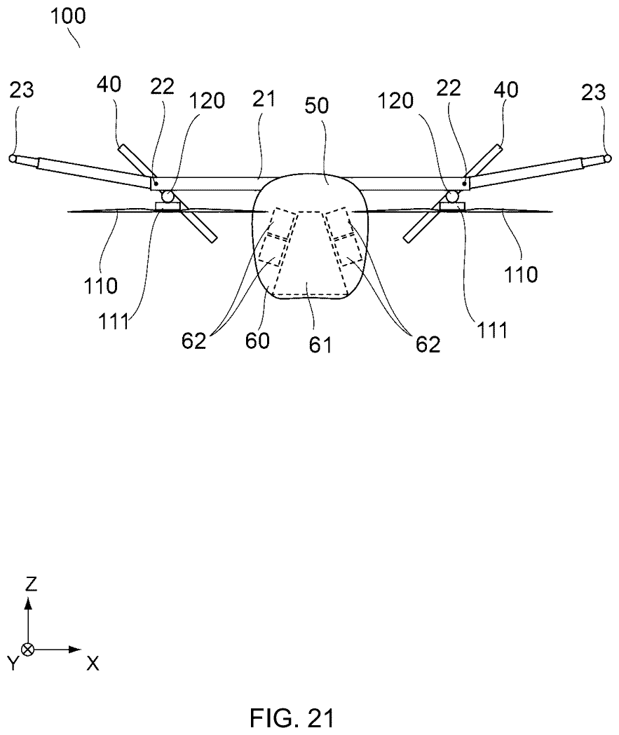

When batteries 62 are contained in the body part 50, the batteries 62 may be located along the direction of opening from above to below in the front view of the aircraft 100, as illustrated in FIG. 21. It is preferable that the batteries 62, which are relatively heavy for payloads of the aircraft 100, are located near a lift generation point of the aircraft 100. In the present embodiment, the lift generation point is the center point of the positions of lift generated by the main wing 21 and the first rotary wing part 11 (i.e., the point of resultant lift). The lift generation point in the Z direction is between the main wing 21 and the first rotary wing part 11. The lift generation points in the X direction and the Y direction are between the aerodynamic center of the main wing 21 and the center of lift of each first rotary wing part 11. In the body part 50 illustrated in FIG. 21, an area above the center height and at the center in the width direction when viewed from the front of the body part 50, is the vicinity of the center of the lift. Such an arrangement allows the weight of the aircraft 100 to be concentrated near the center of the aircraft 100, while maintaining space for a package and other items. This can improve the stability of the aircraft 100.

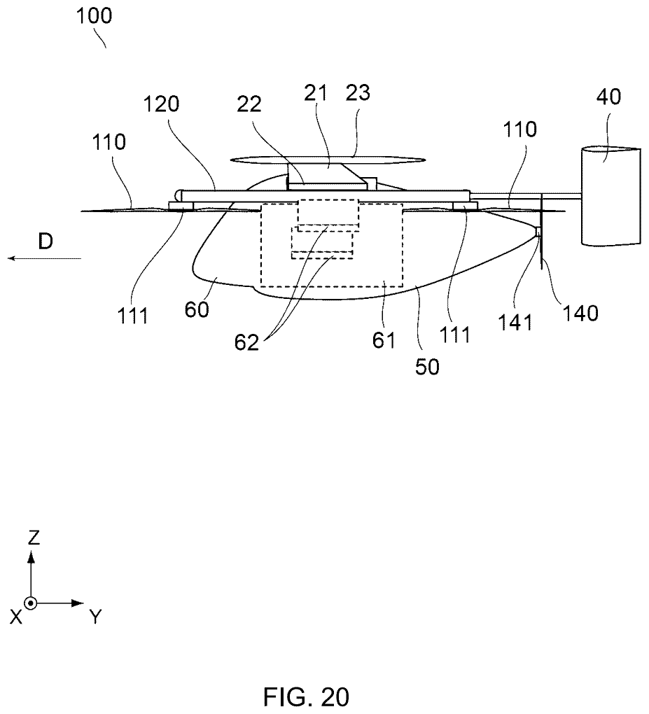

In addition, a payload 61 (e.g., a package, a box for storing a package, a part, a sensor, etc.) may be triangular or trapezoidal in shape. By making the payload 61 in a tapered shape, which is thinner at the top and thicker at the bottom in an area near the center of the aircraft 100, at least a part of the payload 61 can be positioned between the batteries 62, as illustrated in FIGS. 20 and 21, for example. This allows for efficient use of the space inside the body part 50. Thus, an increase in the weight of the body part 50 for package loading can be reduced and flight efficiency can be prevented from lowering.

Furthermore, if the payload 61 is a payload that is detached from the aircraft 100 and dropped or placed on the landing surface, a shape with a large bottom area at the bottom of the payload 61, such as a triangle or trapezoid, will help the payload 61 stand on its own when detached from the aircraft 100 and landed on the ground. This can improve the quality of package transport.

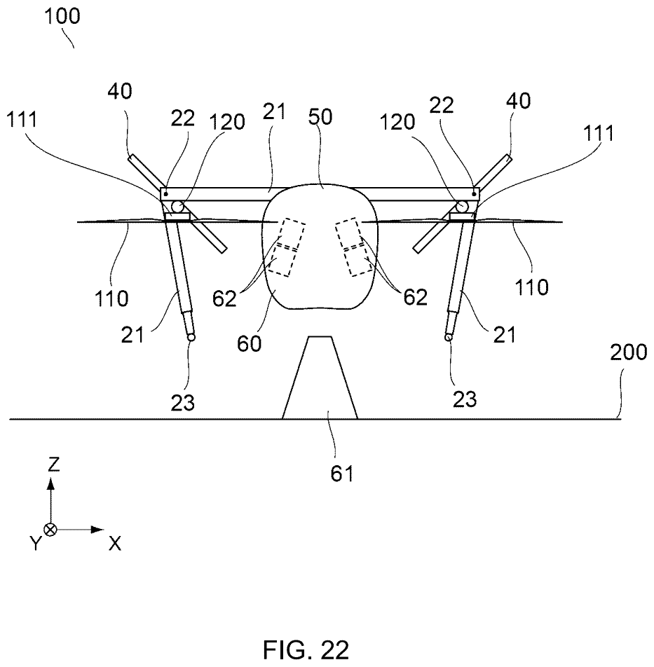

For example, by providing an opening in the bottom of the body part 50 through which a payload can pass, or by allowing it to be opened and closed by a shutter or other means, the payload 61 can be detached downward from the aircraft 100, as illustrated in FIG. 22. This allows for unattended delivery of the payload 61. At this time, if the payload 61 has a shape that extends from above downward, such as a triangle or trapezoid, the payload 61 is less likely to get caught on the body part 50 or parts installed in the body part 50 when the payload 61 is fed downward. This is particularly suitable when the detachment of a package is performed by natural fall due to the dead weight of the payload 61.

The method of mounting the payload 61 onto the aircraft 100 can be any method that does not cause the payload 61 to be unintentionally detached. For example, such a mounting method may be to provide a mounting part on the body part 50 on which a payload can be mounted, as in the present embodiment, or to hook the payload 61 on a hook-like member disposed in the aircraft 100, or to temporarily fix the payload 61 to the aircraft 100 by other physical means such as magnetic attachment or adsorption, or to suspend the payload 61 from the aircraft 100 by a string-like member. However, the mounting method is not limited thereto.

In recent years, various forms of aircrafts have been considered and implemented for use in industries other than home delivery (e.g., inspection, survey, photography, surveillance, agriculture, disaster prevention, etc.). By the aircrafts carrying payloads such as rescue supplies, information-gathering equipment, radio wave repeaters, and other items, it is expected to be able to deliver urgently needed items faster and further away, and to quickly gather information on urgent events such as accidents and disasters.

The above-described embodiments are merely examples to facilitate understanding of the present technology and are not to be construed as limiting the present disclosure. It goes without saying that the present disclosure may be changed and improved without departing from its intent, and that the present disclosure includes equivalents thereof.

### REFERENCE SIGNS LIST

10 Flight section
11 First rotary wing part
14 Second rotary wing part
21 Main wing
22 Rotary portion
23 Landing portion
24 Wingtip portion
30 Shock mitigation device
40 Tail
50 Body part
60 Mounting part
61 Payload
62 Battery
100 Aircraft
110a to 110d Propeller
111a to 111d Motor
120 Frame
121 Landing leg
140 Propeller
141 Motor

1. An aircraft including:
a body part;
a main wing extending in a horizontal direction from the body part so as to intersect with a longitudinal direction; and
a rotary wing part disposed on the aircraft,
the main wing having, at a position in the main wing outside the body part, a rotary portion that is able to rotate an outer portion of the main wing outside the position in the main wing, along a rotation direction with a rotation axis being the longitudinal direction, with respect to an extension direction of the main wing.

2. The aircraft according to claim 1, wherein the main wing includes, at a tip portion of the main wing, a landing portion that is able to be installed on a landing surface in a downward rotated state.

3. The aircraft according to claim 1, wherein the rotary portion is disposed such that the outer portion of the main wing is rotatable by 90 degrees or more with respect to the extension direction of the main wing.

4. The aircraft according to claim 1, wherein the main wing includes a shock mitigation device.

5. The aircraft according to claim 4, wherein the shock mitigation device is disposed on the main wing and is deformable or movable in the extension direction of the main wing.

6. The aircraft according to claim 1, wherein the rotary wing part includes a rotary wing part that generates vertical thrust against the aircraft.

7. The aircraft according to claim 1, wherein the rotary wing part includes a rotary wing part that generates horizontal thrust against the aircraft.

8. The aircraft according to claim 1, wherein the body part is configured to be able to mount a payload and a plurality of batteries inside.

9. The aircraft according to claim 8, wherein the body part is configured to be able to feed the payload downward when the payload is detached.

10. The aircraft according to claim wherein the batteries are positioned with a space in between, in which the payload is mounted.

11. The aircraft according to claim 10, wherein when the body part is viewed from front, the space in which the mounting part is mounted extends from above to below.

12. An aircraft control method for controlling an aircraft,
the aircraft including:
a body part;
a main wing extending in a horizontal direction from the body part so as to intersect with a longitudinal direction; and
a rotary wing part disposed on the aircraft,
the main wing having, at a position in the main wing outside the body part, a rotary portion that is able to rotate an outer portion of the main wing outside the position in the main wing, along a rotation direction with a rotation axis being the longitudinal direction, with respect to an extension direction of the main wing,
the aircraft control method including controlling the main wing to bring the main wing to a folded state by the rotary portion when the aircraft moves downward for landing during flight of the aircraft.

13. The aircraft control method according to claim 12, comprising controlling the main wing to bring a part of the main wing into contact with a landing surface when the aircraft lands.
